(19) United States
(12) Patent Application Publication
(10) Pub. No.: US 2008/0310342 A1
(43) Pub. Date: Dec. 18, 2008

(54) Addressing Messages in a Two-Tier Network

(75) Inventors: Johannes P. Kruys, Harmelen (NL); Shahriar I. Rahman, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/761,831

(22) Filed: Jun. 12, 2007

(51) Int. Cl. H04Q 7/00

(52) U.S. Cl. 370/328

(57) ABSTRACT

In one embodiment, a method includes accessing a frame including a baseline header including a recipient address (RA) field, a transmitter address (TA) field, a destination address (DA) field, and a source address (SA) field. The method includes inserting into the frame a mesh header including a mesh destination address (MDA) field and a mesh source address (MSA) field. The MSA field specifies an address of a first edge node of the wireless mesh network, and the MDA field specifies an address of a second edge node of the wireless mesh network. The first edge node is a first transmitter of the frame with the baseline and mesh headers in the wireless mesh network, and the second edge node is a last recipient of the frame with the baseline and mesh headers in the wireless mesh network. The RA, TA, DA, and SA fields precede the MDA and MSA fields in the frame after insertion of the mesh header into the frame.

### TECHNICAL FIELD

The present disclosure relates generally to communication networks.

### BACKGROUND

A wireless mesh network that supports the routing of frames typically relies on a mesh origin address and a mesh destination address for each frame. If the wireless mesh network routes a frame to or from a device that is not part of the wireless mesh network, the wireless mesh network requires identification of the transmitter of the frame, the mesh nodes that the frame will traverse, and the next-hop receiver of the frame. Without such information, the mesh nodes would likely have to know the addresses of all devices attached to the wireless mesh network, which would be impractical in cases involving large enterprise local area networks (LANs) or the like attached to the wireless mesh network.

### BRIEF DESCRIPTION OF THE DRAWINGS

FIG. 1 illustrates an example system for addressing messages in a two-tier network;

FIG. 2 illustrates an example frame format for addressing messages in a two-tier network;

FIG. 3 illustrates an example method for addressing messages in a two-tier network;

FIG. 4 illustrates another example method for addressing messages in a two-tier network;

FIG. 5 illustrates another example method for addressing messages in a two-tier network; and

FIG. 6 illustrates another example method for addressing messages in a two-tier network.

### DESCRIPTION OF EXAMPLE EMBODIMENTS

Overview

In one embodiment, a method includes accessing a frame including a baseline header including a recipient address (RA) field, a transmitter address (TA) field, a destination address (DA) field, and a source address (SA) field. The method includes inserting into the frame a mesh header including a mesh destination address (MDA) field and a mesh source address (MSA) field. The MSA field specifies an address of a first edge node of the wireless mesh network, and the MDA field specifies an address of a second edge node of the wireless mesh network. The first edge node is a first transmitter of the frame with the baseline and mesh headers in the wireless mesh network, and the second edge node is a last recipient of the frame with the baseline and mesh headers in the wireless mesh network. The RA, TA, DA, and SA fields precede the MDA and MSA fields in the frame after insertion of the mesh header into the frame.

Description

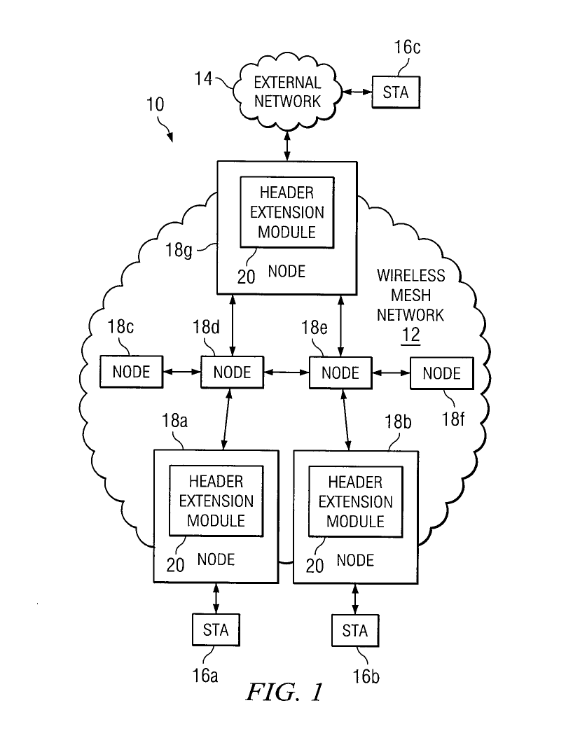

FIG. 1 illustrates an example system 10 for addressing messages in a two-tier network. System 10 includes a wireless mesh network 12 coupled to an external network 14. In particular embodiments, wireless mesh network 12 is an Institute of Electrical and Electronics Engineers (IEEE) 802.11 wireless local area network (WLAN) mesh. In particular embodiments, wireless mesh network 12 is a distribution system (DS) that interconnects multiple basic service sets (BSSs). The present invention contemplates any suitable external network 14 coupled to wireless mesh network 12. As an example and not by way of limitation, external network 14 may be a wired, Layer-2 network. As another example, external network 14 may be one or more portions of the Internet. As another example, external network 14 may be a local area network (LAN), a metropolitan area network (MAN), or a wide area network (WAN). As another example, external network 14 may be an IEEE 802.11 WLAN. As another example, external network 14 may be an IEEE 802.11 WLAN mesh. As another example, external network 14 may be a non IEEE 802.11 network. External network 14 may be a combination of two or more external networks 14. The present invention contemplates any suitable number of external networks 14 coupled to wireless mesh network 12. As an example and not by way of limitation, two or more external networks 14 may be coupled to wireless mesh network 12.

One or more stations (STAs) 16 are coupled to wireless mesh network 12 and to external network 14. As an example and not by way of limitation, STAs 16a and 16b may be coupled to wireless mesh network 12 and STA 16c may be coupled to external network 14. The present invention contemplates any suitable number of any suitable STAs 16 coupled to wireless mesh network 12 and any suitable number of any suitable STAs 16 coupled to external network 14. As an example and not by way of limitation, one or more STAs 16 coupled to wireless mesh network 12 may be devices (such as, for example, fixed or mobile telephones, personal digital assistants (PDAs), desktop or notebook computer systems, printers, media players, or other devices) that each include a medium access control (MAC) and physical layer (PHY) interface to the wireless medium (WM) complying with IEEE 802.11. As another example, one or more STAs 16 coupled to wireless mesh network 12 may be legacy STAs. STAs 16 in system 10 may differ from each other. As an example and not by way of limitation, one or more STAs 16 coupled to wireless mesh network 12 may be endpoints including functionality for communicating with wireless mesh network 12 via one or more wireless links and one or more second STAs 16 coupled to external network 14 may be endpoints including functionality for communicating with external network 14 via one or more wired links, according to particular needs.

Wireless mesh network 12 includes two or more nodes 18. Reference to a node 18 in wireless mesh network 12 encompasses a mesh access point (MAP), a mesh point (MP), a mesh point portal (MPP), or another node or a combination of two or more such nodes, where appropriate. As an example and not by way of limitation, nodes 18a and 18b in wireless mesh network 12 may be MAPs. Nodes 18c, 18d, 18e, and 18f may be MPs. Node 18g may be an MPP or root node. An MAP may be a device in wireless mesh network 12 that includes an MAC and PHY interface to the WM complying with IEEE 802.11 and a hardware, software, or embedded logic component or a combination of two or more such components providing DS functionality for providing STAs 16 access to wireless mesh network 12. An MAP may support a BSS. An MP may be a device in wireless mesh network 12 that includes an MAC and PHY interface to the WM complying with IEEE 802.11 and a hardware, software, or embedded logic component or a combination of two or more such components providing functionality supporting WLAN mesh services. An MPP may be an MP where data communicated between wireless mesh network 12 and an external network 14 enters and exits wireless mesh network 12.

Nodes 18 in wireless mesh network 12 communicate with each other via mesh links. As an example and not by way of limitation, nodes 18a and 18d may communicate with each other via a first mesh link; nodes 18c and 18d may communicate with each other via a second mesh link; nodes 18d and 18e may communicate with each other via a third mesh link; nodes 18d and 18g may communicate with each other via a fourth mesh link; nodes 18e and 18g may communicate with each other via a fifth mesh link; nodes 18b and 18e may communicate with each other via a sixth mesh link; and nodes 18e and 18f may communicate with each other via a seventh mesh link. A mesh link between nodes 18 in wireless mesh network may include one or more mesh links. The present invention contemplates any suitable number of any suitable nodes 18 in wireless mesh network 12 communicating with each other via any suitable number of any suitable mesh links according to, for example, a topology tree.

To communicate with wireless mesh network 12, one or devices outside wireless mesh network 12 may communicate with one or more nodes 18 in wireless mesh network 12 via one or more suitable links between the same. As an example and not by way of limitation, STA 16a may communicate with node 18a (which may be an MAP) via a first wireless link between STA 16a and node 18a. STA 16b may communicate with node 18b (which may also be an MAP) via a second wireless link between STA 16b and node 18b. Node 18a may support a first BSS, which may include STA 16a, and node 18b may support a second BSS, which may include STA 16b. External network 14 may communicate with node 18g (which may be an MPP or root node) via an external link between external network 14 and node 18g. In particular embodiments, a node 18 in wireless mesh network 12 coupled to a device outside wireless mesh network includes a header extension module 20, which includes a hardware, software, or embedded logic component or a combination of two or more such components for modifying the headers of frames entering wireless mesh network 12 from four address fields to six address fields and modifying the headers of frames exiting wireless mesh network 12 from six address fields to four address fields, as described below. Reference to an edge node 18 of wireless mesh network 12 encompasses a node 18 in wireless mesh network 12 coupled to one or more devices (such as, for example, one or more STAs 16 or one or more external networks 14) outside wireless mesh network 12, where appropriate. As an example and not by way of limitation, in system 10, nodes 18a, 18b, and 18g may be edge nodes 18 of wireless mesh network 12. A first edge node 18 along a mesh path may be a first transmitter of a six-address frame in wireless mesh network 12, and a second edge node 18 along the mesh path may be a last recipient of the six-address frame in wireless mesh network 12. First edge node 18 along the mesh path may be responsible for converting or translating a regular IEEE 802.11 four-address frame (such as, for example, a four-address frame received from an STA 16) to a six-address frame. Second edge node 18 along the mesh path may be responsible for converting or translating the six-address frame to a regular IEEE 802.11 four-address frame for transmission out of wireless mesh network 12 to the intended end recipient of the frame.

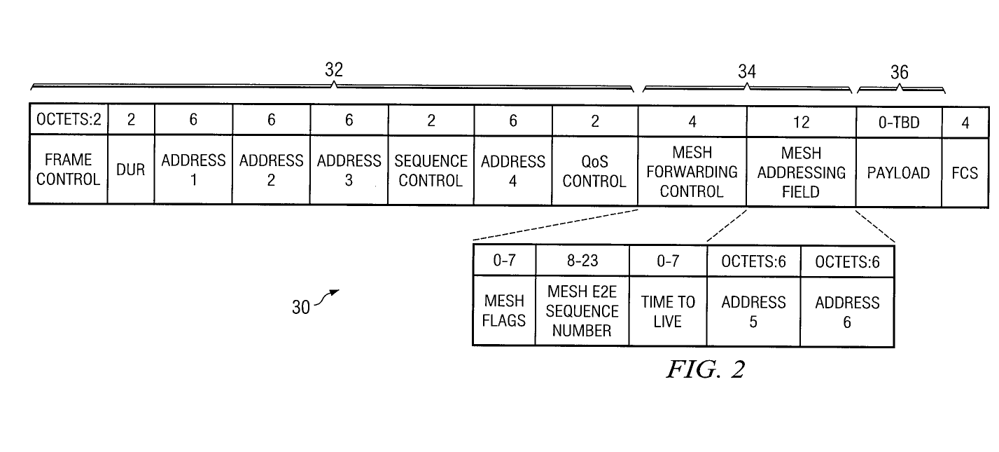

FIG. 2 illustrates an example frame format 30 for addressing messages in a two-tier network. IEEE 802.11 specifies four address fields for a frame: one each for a recipient address (RA), a transmitter address (TA), a source address (SA), and a destination address (DA). The RA of a frame is an address of a device that is an immediate recipient of the frame; the TA is an address of a device that is an immediate transmitter of the frame; the SA is an address of a device that is an original source of the frame; and the DA is an address of a device that is an ultimate destination of the frame. An RA and a TA are one hop away from each other; they are terminals of a link between a receiver and a transmitter. A DA and an SA are terminals of an end-to-end, e.g., IEEE 802, connection, which could include a series of mesh paths connected at MPPs (which could involve tree-based routing (TBR) according to a hybrid wireless mesh protocol (HWMP)), a path between legacy STAs (which could include nodes outside the mesh), or a suitable combination. The four-address scheme enables nodes on different subnetworks to communicate with each other. The same applies to communication between nodes in wireless mesh network 12.

In contrast to the four-address scheme, frame format 30 includes six address fields, labeled Address 1, Address 2, Address 3, Address 4, Address 5, and Address 6 in FIG. 2. In particular embodiments, Addresses 1-4 reside in a baseline header 32 common to all IEEE 802.11 frames and Addresses 5-6 reside in a mesh header 34 inserted between baseline header 32 and a mesh payload 36. In particular embodiments, Address 1 indicates an RA, Address 2 indicates a TA, Address 3 indicates a DA, Address 4 indicates an SA, Address 5 indicates a mesh destination address (MDA), and Address 6 indicates a mesh source address (MSA). As an example and not by way of limitation, an MDA and an MSA may be terminals of a mesh path between a mesh destination (which may be an MP, an MPP, or an MAP in wireless mesh network 12) and a mesh source (which may be an MP, an MPP, or an MAP in wireless mesh network 12). In particular embodiments, Address 1 indicates an RA, Address 2 indicates a TA, Address 3 indicates an MDA, Address 4 indicates an MSA, Address 5 indicates a DA, and Address 6 indicates an SA.

In particular embodiments, mesh header 34 is encrypted. IEEE 802.11 MAC hardware that encrypts the contents of an IEEE 802.11 frame after the Quality of Service (QoS) Control field may be unable to employ mesh edge-to-edge encryption, since the intermediate nodes may fail to perform any route lookup based on Address 5 or Address 6, which are on the forwarding path through the mesh. Hence, we need to indicate the presence of Mesh Forwarding Control (MFC) and Mesh Address Extensions (MAEs) in IEEE 802.11 Frame Control. The frames may be data frames, e.g., Frame Control:Type=0x01 for data and two separate bits for MFC and MAE presence indication in Frame Control:SubType between 0x1100 and 0x1111. Once in place, IEEE 802.11 MAC hardware for MAPs, MPs, and MPPs may be able to detect MFC and MAE and take appropriate actions at the edge, enabling edge-to-edge encryption.

In particular embodiments, a six-address scheme supports routing at the link, e.g., MAC, layer of frames to and from devices attached to a wireless mesh network, such as, for example, wireless mesh network 12. In particular embodiments, to support devices or networks attached to a wireless mesh network, the wireless mesh network uses a second layer of addressing that enables an originating mesh node to provide to a destination mesh node an address of an attached source node and an address of an attached destination node. In particular embodiments, to maintain compatibility with existing LAN protocol stacks, a mesh header field used only by mesh nodes (and not by devices attached to the wireless mesh network) carries the second layer of addressing. Therefore, the use of the six-address scheme is transparent to non mesh devices. In particular embodiments, the communication of a frame from a first attached device to a second attached device across a wireless mesh network makes use of two extended addressing fields, MDA and MSA, that are part of the mesh-level payload.

Consider the following example, provided for the sake of explanation and not limitation. An attached device may communicate a frame to a first mesh edge node neighboring the attached device. The frame may have a header that includes four address fields: one each for an RA, a TA, a DA, and an SA. When the frame leaves the attached device, the RA field may indicate the address of the first mesh edge node, the TA field may indicate the address of the attached device, the DA field may indicate the address of the destination of the frame, and the SA field may indicate the address of the attached device. When the first mesh edge node receives the frame, the first mesh edge node may extend the header of the frame to include six address fields: one each for an RA, a TA, a DA, an SA, an MDA, and an MSA. In the frame, Address 1 may indicate the RA, Address 2 may indicate the TA, Address 3 may indicate the DA, Address 4 may indicate the SA, Address 5 may indicate the MDA, and Address 6 may indicate the MSA. Alternatively, in the frame Address 1 may indicate the RA, Address 2 may indicate the TA, Address 3 may indicate the MDA, Address 4 may indicate the MSA, Address 5 may indicate the DA, and Address 6 may indicate the SA. When the frame leaves the first mesh edge node, the RA field may indicate the address of the next mesh node to receive the corresponding frame, the TA field may indicate the address of the first mesh edge node, the DA field may indicate the address of the destination of the frame, the SA field may indicate the address of the attached device, the MDA field may indicate the address of a second mesh edge node (which may communicate the frame out of the wireless mesh network), and the MSA field may indicate the address of the first mesh edge node. As the frame travels through the wireless mesh network, the RA and TA fields change, but the DA, MDA, SA, and MSA fields remain unchanged. When the frame reaches the second mesh edge node, or destination mesh node, the second mesh edge node may remove the mesh header, set the RA field to indicate the address of the next-hop device outside the wireless mesh network to receive the frame, and set the TA field to indicate the address of the second mesh edge node. If the originator or the destination is a mesh node, the address of the mesh node may populate the SA or DA field, as appropriate.

The Transparent Interconnection of Lots of Links (TRILL) working group of the Internet Engineering Task Force (IETF) has worked on separating device populations in terms of mesh members and non mesh members. The architecture proposed by the TRILL working group generates tunnels between mesh edge nodes, and traffic between devices attached to the wireless mesh network flow through the tunnels, which is similar to the encapsulation of frames traversing the wireless mesh network. In contrast, particular embodiments define a mesh-specific header that enables mesh nodes to route traffic to or from devices attached to the wireless mesh network without knowing anything about the devices. In particular embodiments, an addressing scheme for wireless mesh networks uses six address fields to enable mesh edge nodes to transparently pass non mesh addresses to each other. In particular embodiments, all mesh nodes in a wireless mesh network need not be aware of the addresses of devices outside the wireless mesh network. Particular embodiments provide full transparency for legacy LAN devices. Particular embodiments are compatible with bridging according to IEEE 802.3.

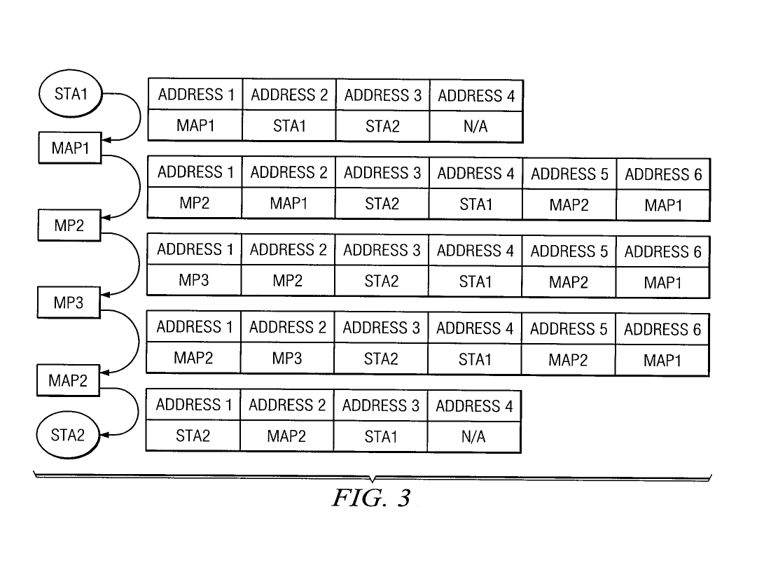

FIG. 3 illustrates an example method for addressing messages in a two-tier network. STA1 in FIG. 3 represents STA 16a in FIG. 1; MAP1 represents node 18a; MP2 represents node 18d; MP3 represents node 18e; MAP2 represents node 18b; and STA2 represents STA 16b. Nodes 18a and 18b are MAPs, and nodes 18d and 18e are MPs. In FIG. 3, a frame travels from STA1 to STA 2 through MP2 and MP3 according to hybrid wireless mesh protocol (HWMP) on-demand routing or radio-aware optimum link state routing (RA-OLSR). When the frame leaves STA1, Address 1 indicates an address of MAP1 (which is the RA); Address 2 indicates an address of STA1 (which is the TA); Address 3 indicates an address of STA2 (which is the DA); and Address 4 (which will indicate the SA) is empty. MAP1 inserts Address 5 and Address 6 into the frame, sets Address 5 to indicate and address of MAP2 (which is the MDA) and Address 6 to indicate an address of MAP1 (which is the MSA), updates Address 1, Address 2, and Address 4, and communicates the frame to MP2. The frame travels through MP2 and MP3 and reaches MAP2. MAP2 removes Address 5 and Address 6 from the frame, updates Address 1, Address 2, Address 3, and Address 4, and communicates the frame to STA2. As an alternative, on the hops from MAP1 to MP2, from MP2 to MP3, and from MP3 to MAP2, Address 3 and Address 4 may carry the MDA and the MSA, respectively, and Address 5 and Address 6 may carry the DA and the SA, respectively.

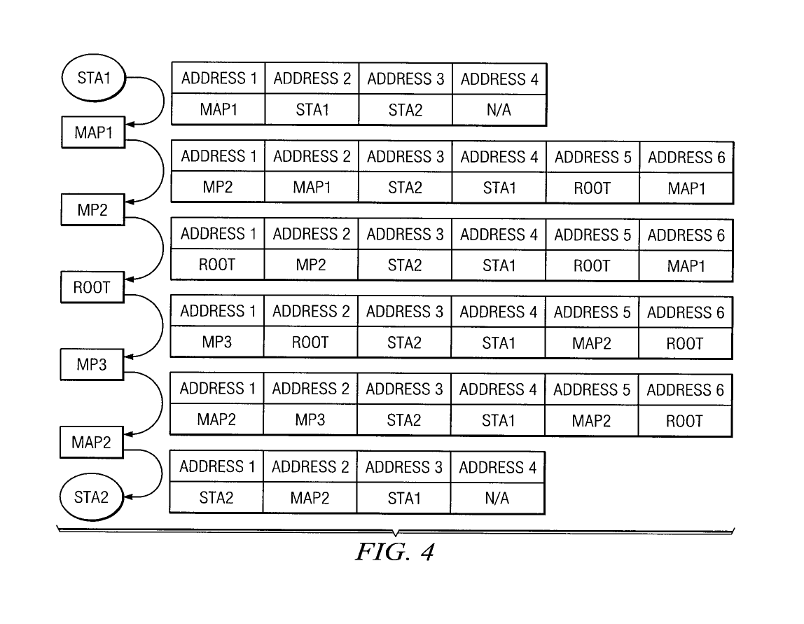

FIG. 4 illustrates another example method for addressing messages in a two-tier network. STA1 in FIG. 4 represents STA 16a in FIG. 1; MAP1 represents node 18a; MP2 represents node 18d; ROOT represents node 18g; MP3 represents node 18e; MAP2 represents node 18b; and STA2 represents STA 16b. Nodes 18a and 18b are MAPs, nodes 18d and 18e are MPs, and node 18g is an MPP or root node. In FIG. 4, a frame travels from STA1 to STA 2 through a root node according to HWMP TBR. When the frame leaves STA1, Address 1 indicates an address of MAP1 (which is the RA); Address 2 indicates an address of STA1 (which is the TA); Address 3 indicates an address of STA2 (which is the DA); and Address 4 (which will indicate the SA) is empty. MAP1 inserts Address 5 and Address 6 into the frame, sets Address 5 to indicate an address of the root node (which serves as the MDA until the frame reaches the root node) and Address 6 to indicate an address of MAP1 (which is the MSA), updates Address 1, Address 2, and Address 4, and communicates the frame to MP2. The frame then travels through MP2 to the root node. The root node determines that MAP2 is the mesh destination of the frame, sets Address 5 to indicate and address of MAP 2, updates Address 1 and Address 2, and communicates the frame to MP3. The frame then travels through MP3 to MAP2. MAP2 removes Address 5 and Address 6 from the frame, updates Address 1, Address 2, Address 3, and Address 4, and communicates the frame to STA2. As an alternative, on the hops from MAP1 to MP2, from MP2 to the root node, from the root node to MP3, and from MP3 to MAP2, Address 3 and Address 4 may carry the MDA and the MSA, respectively, and Address 5 and Address 6 may carry the DA and the SA, respectively.

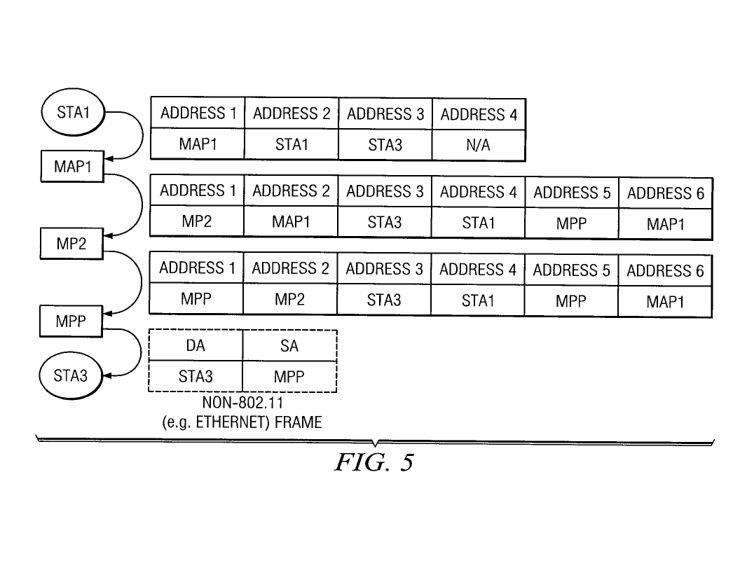

FIG. 5 illustrates another example method for addressing messages in a two-tier network. STA1 in FIG. 5 represents STA 16a in FIG. 1; MAP1 represents node 18a; MP2 represents node 18d; MPP represents node 18g; and STA3 represents STA 16c. Node 18a is a MAP, nodes 18d is an MP, and node 18g is an MPP. In FIG. 5, a frame travels from STA1 to STA3 through wireless mesh network 12 and external network 14, which in this example is a non 802.11, e.g., Ethernet, network. When the frame leaves STA1, Address 1 indicates an address of MAP1 (which is the RA); Address 2 indicates an address of STA1 (which is the TA); Address 3 indicates an address of STA2 (which is the DA); and Address 4 (which will indicate the SA) is empty. MAP1 inserts Address 5 and Address 6 into the frame, sets Address 5 to indicate an address of MPP (which is the MDA) and Address 6 to indicate and address of MAP1 (which is the MSA), updates Address 1, Address 2, and Address 4, and communicates the frame to MP2. MP2 updates Address 1 and Address 2 and communicates the frame to MPP. MPP removes Address 3, Address 4, Address 5, and Address 6 from the frame, updates Address 1 and Address 2 to indicate an address of STA3 (which is the DA) and an address of MPP (which is the SA with respect to external network 14), and communicates the frame to STA3 via external network 14. As an alternative, on the hops from MAP1 to MP2 and from MP2 to MPP, Address 3 and Address 4 may carry the MDA and the MSA, respectively, and Address 5 and Address 6 may carry the DA and the SA, respectively.

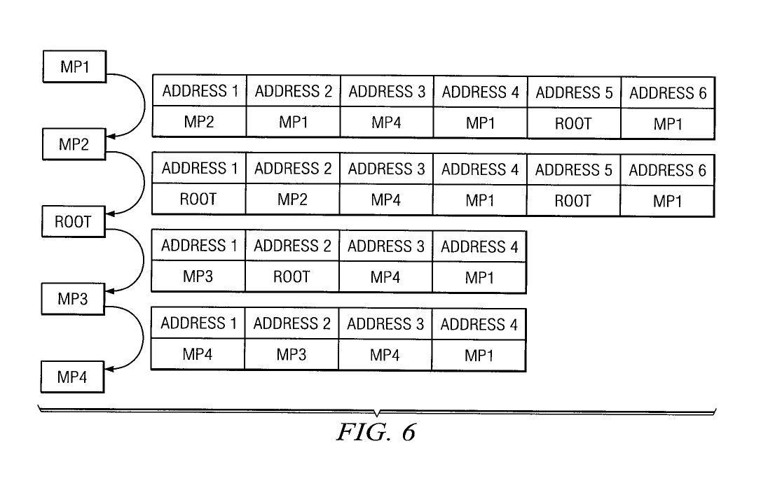

FIG. 6 illustrates another example method for addressing messages in a two-tier network. MP1 in FIG. 6 represents node 18c in FIG. 1; MP2 represents node 18d; ROOT represents node 18g; MP3 represents node 18e; and MP4 represents node 18f. Nodes 18c, 18d, 18e, and 18f are MPs, and node 18g is an MPP. In FIG. 6, a frame travels from MP1 to MP4 through a root node according to HWMP TBR. When the frame leaves MP1, Address 1 indicates an address of MP2 (which is the RA); Address 2 indicates an address of MP1 (which is the TA); Address 3 indicates an address of MP4 (which is the DA); Address 4 indicates the address of MP1 (which is the SA); Address 5 indicates an address of the root node (which is the MDA); and Address 6 indicates the address of MP1 (which is the MSA). MP2 updates Address 1 and Address 2 and communicates the frame to the root node. The root node removes Address 5 and Address 6 and updates Address 1, Address 2, Address 3, and Address 4 to indicate the addresses of MP3, the root node, MP4, and MP1, respectively, and communicates the frame to MP3. MP3 updates Address 1 and Address 2 and communicates the frame to MP4. As an alternative, on the hops from MP1 to MP2 and from MP2 to the root node, Address 3 and Address 4 may carry the MDA and the MSA, respectively, and Address 5 and Address 6 may carry the DA and the SA, respectively.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. An apparatus comprising:
a first interface operable to communicate with one or more nodes outside a wireless mesh network;
a second interface operable to communicate with one or more nodes in the wireless mesh network; and
logic embodied in one or more tangible media for execution and when executed operable to:
access a frame received at the first interface from one of the nodes outside the wireless mesh network, the frame comprising a baseline header comprising a recipient address (RA) field, a transmitter address (TA) field, a destination address (DA) field, and a source address (SA) field;
insert into the frame a mesh header comprising a mesh destination address (MDA) field and a mesh source address (MSA) field, the MSA field specifying an address of a first edge node of the wireless mesh network, the MDA field specifying an address of a second edge node of the wireless mesh network, the first edge node being a first transmitter of the frame with the baseline and mesh headers in the wireless mesh network, the second edge node being a last recipient of the frame with the baseline and mesh headers in the wireless mesh network, the RA, TA, DA, and SA fields preceding the MDA and MSA fields in the frame after insertion of the mesh header into the frame;
provide the frame with the baseline and mesh headers to the second interface for communication to the next recipient of the frame in the wireless mesh network.

2. The apparatus of claim 1, wherein the mesh header comprises a mesh forwarding control field and a mesh addressing field, the mesh addressing field comprising the MDA and MSA fields, the mesh forwarding control field preceding the mesh addressing field in the mesh header.

3. The apparatus of claim 1, wherein the logic is further operable to:
update the RA field to specify an address of a next recipient of the frame in the wireless mesh network; and
update the TA field to specify the address of the first edge node.

4. The apparatus of claim 1, wherein the apparatus is a mesh point portal (MPP).

5. The apparatus of claim 1, wherein the next recipient of the frame in the wireless mesh network is a mesh access point (MAP) or a mesh point (MP) in the wireless mesh network.

6. The apparatus of claim 1, wherein the MSA field follows the MDA field in the header.

7. The apparatus of claim 1, wherein the MDA field follows the MSA field in the header.

8. The apparatus of claim 1, wherein, in the header:
the SA field follows the DA field;
the DA field follows the TA field; and
the TA field follows the RA field.

9. The apparatus of claim 1, wherein the wireless mesh network is an Institute of Electrical and Electronics Engineers (IEEE) 802.11 wireless local area network (WLAN) mesh.

10. The apparatus of claim 9, wherein the one or more nodes outside the wireless mesh network are nodes in another IEEE 802.11 WLAN mesh.

11. The apparatus of claim 1, wherein the one or more nodes outside the wireless mesh network are nodes in a wired, Layer-2 network.

12. The apparatus of claim 1, wherein the wireless mesh network is a distribution system (DS) interconnecting a plurality of basic service sets (BSSs).

13. A method comprising:
accessing a frame received at a first interface operable to communicate with one or more nodes outside a wireless mesh network, the first interface having received the frame from one of the nodes outside the wireless mesh network, the frame comprising a baseline header comprising a recipient address (RA) field, a transmitter address (TA) field, a destination address (DA) field, and a source address (SA) field;
inserting into the frame a mesh header comprising a mesh destination address (MDA) field and a mesh source address (MSA) field, the MSA field specifying an address of a first edge node of the wireless mesh network, the MDA field specifying an address of a second edge node of the wireless mesh network, the first edge node being a first transmitter of the frame with the baseline and mesh headers in the wireless mesh network, the second edge node being a last recipient of the frame with the baseline and mesh headers in the wireless mesh network, the RA, TA, DA, and SA fields preceding the MDA and MSA fields in the frame after insertion of the mesh header into the frame;
providing the frame with the baseline and mesh headers to a second interface for communication to the next recipient of the frame in the wireless mesh network, the second interface being operable to communicate with one or more nodes in the wireless mesh network.

14. The method of claim 13, wherein the mesh header comprises a mesh forwarding control field and a mesh addressing field, the mesh addressing field comprising the MDA and MSA fields, the mesh forwarding control field preceding the mesh addressing field in the mesh header.

15. The method of claim 13, further comprising, before providing the frame to the second interface:
updating the RA field to specify an address of a next recipient of the frame in the wireless mesh network; and
updating the TA field to specify the address of the first edge node.

16. The method of claim 13, executed at a mesh point portal (MPP).

17. The method of claim 13, wherein the next recipient of the frame in the wireless mesh network is a mesh access point (MAP) or a mesh point (MP) in the wireless mesh network.

18. The method of claim 13, wherein the MSA field follows the MDA field in the header.

19. The method of claim 13, wherein the MDA field follows the MSA field in the header.

20. The method of claim 13, wherein, in the header:
the SA field follows the DA field;
the DA field follows the TA field; and
the TA field follows the RA field.

21. The method of claim 13, wherein the wireless mesh network is an Institute of Electrical and Electronics Engineers (IEEE) 802.11 wireless local area network (WLAN) mesh.

22. The method of claim 21, wherein the one or more nodes outside the wireless mesh network are nodes in another IEEE 802.11 WLAN mesh.

23. The method of claim 13, wherein the one or more nodes outside the wireless mesh network are nodes in a wired, Layer-2 network.

24. The method of claim 13, wherein the wireless mesh network is a distribution system (DS) interconnecting a plurality of basic service sets (BSSs).

25. An apparatus comprising:
a first interface operable to communicate with one or more nodes in a wireless mesh network;
a second interface operable to communicate with one or more nodes outside the wireless mesh network; and
logic embodied in one or more tangible media for execution and when executed operable to:
access a frame received at the first interface from one of the nodes in the wireless mesh network, the frame comprising a baseline header comprising a recipient address (RA) field, a transmitter address (TA) field, a destination address (DA) field, and a source address (SA) field and a mesh header comprising a mesh destination address (MDA) field and a mesh source address (MSA) field, the RA, TA, DA, and SA fields preceding the MDA and MSA fields in the frame, the MSA field specifying an address of a first edge node of the wireless mesh network, the MDA field specifying an address of a second edge node of the wireless mesh network, the first edge node being a first transmitter of the frame with the baseline and mesh headers in the wireless mesh network, the second edge node being a last recipient of the frame with the baseline and mesh headers in the wireless mesh network;
remove the mesh header from the frame;
provide the frame with baseline header but without the mesh header to the second interface for communication to the next recipient of the frame outside the wireless mesh network.

26. The apparatus of claim 25, wherein the mesh header comprises a mesh forwarding control field and a mesh addressing field, the mesh addressing field comprising the MDA and MSA fields, the mesh forwarding control field preceding the mesh addressing field in the mesh header.

27. The apparatus of claim 25, wherein the logic is further operable, before providing the frame to the second interface, to:
update the RA field to specify an address of a next recipient of the frame outside the wireless mesh network; and
update the TA field to specify the address of the second edge node.

28. The apparatus of claim 25, wherein the apparatus is a mesh point portal (MPP).

29. The apparatus of claim 25, wherein the next recipient of the frame in the wireless mesh network is a mesh access point (MAP) or a mesh point (MP) in the wireless mesh network.

30. The apparatus of claim 25, wherein the MSA field follows the MDA field in the header.

31. The apparatus of claim 25, wherein the MDA field follows the MSA field in the header.

32. The apparatus of claim 25, wherein, in the header:
the SA field follows the DA field;
the DA field follows the TA field; and
the TA field follows the RA field.

33. The apparatus of claim 25, wherein the wireless mesh network is an Institute of Electrical and Electronics Engineers (IEEE) 802.11 wireless local area network (WLAN) mesh.

34. The apparatus of claim 33, wherein the one or more nodes outside the wireless mesh network are nodes in another IEEE 802.11 WLAN mesh.

35. The apparatus of claim 25, wherein the one or more nodes outside the wireless mesh network are nodes in a wired, Layer-2 network.

36. The apparatus of claim 25, wherein the wireless mesh network is a distribution system (DS) interconnecting a plurality of basic service sets (BSSs).

37. A method comprising:
accessing a frame received at a first interface operable to communicate with one or more nodes in a wireless mesh network, the first interface having received the frame from one of the nodes in the wireless mesh network, the frame comprising a baseline header comprising a recipient address (RA) field, a transmitter address (TA) field, a destination address (DA) field, and a source address (SA) field and a mesh header comprising a mesh destination address (MDA) field and a mesh source address (MSA) field, the RA, TA, DA, and SA fields preceding the MDA and MSA fields in the frame, the MSA field specifying an address of a first edge node of the wireless mesh network, the MDA field specifying an address of a second edge node of the wireless mesh network, the first edge node being a first transmitter of the frame with the baseline and mesh headers in the wireless mesh network, the second edge node being a last recipient of the frame with the baseline and mesh headers in the wireless mesh network;
removing the mesh header from the frame;
providing the frame with the baseline header but without the mesh header to a second interface for communication to the next recipient of the frame outside the wireless mesh network, the second interface being operable to communicate with one or more nodes outside the wireless mesh network.

38. The method of claim 37, wherein the mesh header comprises a mesh forwarding control field and a mesh addressing field, the mesh addressing field comprising the MDA and MSA fields, the mesh forwarding control field preceding the mesh addressing field in the mesh header.

39. The method of claim 37, further comprising, before providing the frame to the second interface:
updating the RA field to specify an address of a next recipient of the frame outside the wireless mesh network; and
updating the TA field to specify an address of the second edge node.

40. The method of claim 37, executed at a mesh point portal (MPP).

41. The method of claim 37, wherein the next recipient of the frame in the wireless mesh network is a mesh access point (MAP) or a mesh point (MP) in the wireless mesh network.

42. The method of claim 37, wherein the MSA field follows the MDA field in the header.

43. The method of claim 37, wherein the MDA field follows the MSA field in the header.

44. The method of claim 37, wherein, in the header:
the SA field follows the DA field;
the DA field follows the TA field; and
the TA field follows the RA field.

45. The method of claim 37, wherein the wireless mesh network is an Institute of Electrical and Electronics Engineers (IEEE) 802.11 wireless local area network (WLAN) mesh.

46. The method of claim 45, wherein the one or more nodes outside the wireless mesh network are nodes in another IEEE 802.11 WLAN mesh.

47. The method of claim 37, wherein the one or more nodes outside the wireless mesh network are nodes in a wired, Layer-2 network.

48. The method of claim 37, wherein the wireless mesh network is a distribution system (DS) interconnecting a plurality of basic service sets (BSSs).

49. A system comprising:
a first edge node in a wireless mesh network, the first edge node being operable to:
receive a frame from one a first node outside the wireless mesh network, the frame comprising a baseline header comprising a recipient address (RA) field, a transmitter address (TA) field, a destination address (DA) field, and a source address (SA) field;
insert into the frame a mesh header comprising a mesh destination address (MDA) field and a mesh source address (MSA) field, the MSA field specifying an address of the first edge node of the wireless mesh network, the MDA field specifying an address of a second edge node of the wireless mesh network, the first edge node being a first transmitter of the frame with the baseline and mesh headers in the wireless mesh network, the second edge node being a last recipient of the frame with the baseline and mesh headers in the wireless mesh network, the RA, TA, DA, and SA fields preceding the MDA and MSA fields in the frame after insertion of the mesh header into the frame; and
communicate the frame with the baseline and mesh headers to the next recipient of the frame in the wireless mesh network; and
the second edge node, operable to:
receive the frame with the baseline and mesh headers from a node in the wireless mesh network;
remove the mesh header from the frame; and
communicate the frame with the baseline header but without the mesh header to the next recipient of the frame outside the wireless mesh network.
